(19) United States
(12) Patent Application Publication
(10) Pub. No.: US 2014/0281635 A1
(43) Pub. Date: Sep. 18, 2014

(54) REDUCING POWER CONSUMPTION DURING IDLE STATE

(71) Applicant: Naveen Gopal REDDY, Bangalore (IN)

(72) Inventor: Naveen Gopal REDDY, Bangalore (IN)

(21) Appl. No.: 14/212,135

(22) Filed: Mar. 14, 2014

(30) Foreign Application Priority Data
Mar. 15, 2013 (IN) 1128/CHE/2013

(51) Int. Cl. G06F 1/32

(52) U.S. Cl. CPC G06F 1/3234
USPC 713/323

(57) ABSTRACT

Methods and apparatus relating to power consumption reduction during idle state(s) are described. In one embodiment, logic transfers control of a power state of a device to one or more general purpose input output signals. The logic generates a signal to control the power state of the device via a switch. Also, the logic generates the signal, at least in part, based on the one or more general purpose input output signals and a control enable signal. Other embodiments are also claimed and disclosed.

### FIELD

The present disclosure generally relates to the field of electronics. More particularly, an embodiment of the invention relates to power consumption reduction during idle state(s).

### BACKGROUND

To reduce power consumption, some systems include processors with the ability to perform at various low power (Cx) or idle states. Each C state may indicate a certain level of functionality and corresponding power state. For example, C0 may indicate the processor is operating at normal levels, C1 may indicate the processor is not executing instructions but may return to an executing state quickly, etc.

However, as the need for more power efficient systems arises, e.g., to allow for all day operation using battery power from a single charge, such coarse power reduction solutions that are solely based on processor states may fall short.

### BRIEF DESCRIPTION OF THE DRAWINGS

The detailed description is provided with reference to the accompanying figures. In the figures, the left-most digit(s) of a reference number identifies the figure in which the reference number first appears. The use of the same reference numbers in different figures indicates similar or identical items.

FIGS. 1, 5, 6, and 7 illustrate block diagrams of embodiments of computing systems, which may be utilized to implement various embodiments discussed herein.

FIGS. 2-3 illustrate block diagrams of components of a power management architecture that may be used to implement one or more embodiments discussed herein.

FIG. 4 illustrates a flow diagram of a method according to an embodiment.

### DETAILED DESCRIPTION

In the following description, numerous specific details are set forth in order to provide a thorough understanding of various embodiments. However, various embodiments of the invention may be practiced without the specific details. In other instances, well-known methods, procedures, components, and circuits have not been described in detail so as not to obscure the particular embodiments of the invention. Further, various aspects of embodiments of the invention may be performed using various means, such as integrated semiconductor circuits (“hardware”), computer-readable instructions organized into one or more programs (“software”), or some combination of hardware and software. For the purposes of this disclosure reference to “logic” shall mean either hardware, software, firmware, or some combination thereof.

Power management is crucial for mobile devices (such as phones, tablets, UMPC (Ultra-Mobile Personal Computer), laptop computers, etc.) and hence it is critical that such platforms are highly optimized from a power and performance point of view. For example, one of the requirements of Ultrabook platforms is to provide whole day battery life (e.g., from a single charge) to the users in a thin form factor. Also, platform designers have to focus on minimizing idle power consumption in platform to meet the Microsoft Windows® 8 standby power requirements. Minimizing platform idle power consumption can also enable designers to use a smaller battery to achieve the battery life targets or weight goals, along with new form factor designs.

Moreover, to minimize platform power consumption in idle states Ultrabook platforms may support Run Time D3 (RTD3) where platform devices can be selectively turned off while in S0iX system states to minimize platform power consumption. Which of the devices can be turned off is decided based on user activity and the need for a particular device and the exit latencies involved. In some implementations, these power gating switches may be controlled at the hardware level through the General Purpose Input Output (GPIO) signals generated by an I/O (Input/Output, also referred to as IO herein) complex (e.g. responsible for control of I/O pathways in and out of a platform or system) which may also be referred to herein interchangeably as a Platform Controller Hub (PCH), a bridge logic, etc. In turn, it is the platform designer's responsibility to map the GPIOs to the specific power gating devices and communicate to the software designers to drive the appropriate logic to control the switches. As discussed herein, “software” is intended to encompass software application(s), operating system(s), firmware, etc. including instructions stored, e.g., on non-transitory, computer-readable medium.

Generally, “S0ix” refers to improved idle power state(s) achieved by platform-level power management that is event driven (e.g., based on OS or software application input) instead of traditional idle power state that is driven either by a user or based on a determination that a platform has been idle for too long (based on a pre-programmed time). In some embodiments, at least some of the power consumption states discussed herein may be in accordance with or similar to those defined under Advanced Configuration and Power Interface (ACPI) specification, Revision 5, December 2011. As discussed herein, “S3” generally refers to a power state such as standby, sleep, and/or suspend to Random Access Memory (RAM), e.g., while the RAM remains powered to maintain data correctness. “Sx” refers to deeper sleep (such as S3, S4, or S5), etc.

Some embodiments provide power consumption reduction (e.g., in System on Chip (SOC) platforms) during idle state(s). In an embodiment, power consumption through RTD3 switches are controlled by modifying one or more signals. In one embodiment, logic (e.g., coupled between a I/O complex/bridge and a power switch to a device) may control the power state of the device.

The techniques discussed herein may be used in any type of a computing system with power consumption settings, such as the systems discussed with reference to FIGS. 1 and 5-6 (which may include mobile devices such as phones, tablets, UMPC (Ultra-Mobile Personal Computer), laptop computers, etc.). More particularly, FIG. 1 illustrates a block diagram of a computing system 100, according to an embodiment of the invention. The system 100 may include one or more processors 102-1 through 102-N (generally referred to herein as “processors 102” or “processor 102”). The processors 102 may communicate via an interconnection network or bus 104. Each processor may include various components some of which are only discussed with reference to processor 102-1 for clarity. Accordingly, each of the remaining processors 102-2 through 102-N may include the same or similar components discussed with reference to the processor 102-1.

In an embodiment, the processor 102-1 may include one or more processor cores 106-1 through 106-M (referred to herein as “cores 106” or more generally as “core 106”), a shared cache 108, and/or a router 110. The processor cores 106 may be implemented on a single integrated circuit (IC) chip. Moreover, the chip may include one or more shared and/or private caches (such as cache 108), buses or interconnections (such as a bus or interconnection network 112), memory controllers (such as those discussed with reference to FIGS. 5-6), or other components.

In one embodiment, the router 110 may be used to communicate between various components of the processor 102-1 and/or system 100. Moreover, the processor 102-1 may include more than one router 110. Furthermore, the multitude of routers 110 may be in communication to enable data routing between various components inside or outside of the processor 102-1.

The shared cache 108 may store data (e.g., including instructions) that are utilized by one or more components of the processor 102-1, such as the cores 106. For example, the shared cache 108 may locally cache data stored in a memory 114 for faster access by components of the processor 102. In an embodiment, the cache 108 may include a mid-level cache (such as a level 2 (L2), a level 3 (L3), a level 4 (L4), or other levels of cache), a last level cache (LLC), and/or combinations thereof. Moreover, various components of the processor 102-1 may communicate with the shared cache 108 directly, through a bus (e.g., the bus 112), and/or a memory controller or hub. As shown in FIG. 1, in some embodiments, one or more of the cores 106 may include a level 1 (L1) cache 116-1 (generally referred to herein as “L1 cache 116”).

In one embodiment, logic 140 controls and/or reduces power consumption by one or more devices 150 during idle state(s). For example, logic 140 is coupled between I/O complex 130 and one or more devices 150 and controls power consumption by the one or more devices 150 via modifying one or more signals to control RTD3 switch(es). While I/O complex 130 may be used in some embodiments, other types of logic such as a bridge, control logic, etc. may be used instead of or in addition to a I/O complex to couple logic 140 to the system 100 (e.g., via bus/interconnection 104). In some embodiments, power consumption control may also be achieved (e.g., by logic 140) based, at least in part, on input from OS (Operating System) software and/or software application(s) (e.g., that may be stored in the memory 114).

Moreover, the ability to control the level of power consumption may be used to optimize platform power consumption in response to various determinations such as based on the workload, scenario, usage, one or more sensed temperature values (e.g., as detected by one or more temperature sensors (not shown) located within proximity of one or more of the components of the systems discussed herein, e.g., with reference to FIGS. 1, 2, 3, 5, and/or 6), etc. Furthermore, at least some OS operations discussed herein may be interchangeably performed by software applications, firmware, etc.

FIGS. 2-3 illustrate block diagrams of components of a power management architecture that may be used to implement one or more embodiments discussed herein.

In some implementations, RTD3 power gating may be achieved by utilizing a I/O complex GPIO to control the enable input of a FET (Field Effect Transistor) switch which can turn off the power to a device (such as an IO device). Unless the I/O complex puts the GPIO in a defined state during a fresh power up state (such as G3 exit for SUS (Suspend) well GPIO), a Pull up resistor (for active high enable switch that is coupled between the FET switch and the I/O complex GPIO) may be necessary on the I/O complex GPIO to ensure that the GPIO is in a defined state for the device to be powered until BIOS (Basic Input Output System) can come up and take control of the GPIO. However, such a Pull up resistor would result in idle power consumption while in low power states (when the switch is turned off) by driving a low on the GPIO. Even for a Pull up value of 100K on a 3.3V rail, this could result in a power loss of ˜0.11 mW. If there are multiple devices which have this configuration, the result in power loss may be in the range of 1-2 mW, which is significant power loss when targeting for a platform idle power target of 20-25 mW, for example.

Referring to FIG. 2, the idle power consumption is reduced by using logic 140 in an embodiment. As shown, logic 140 receives the GPIO signals from I/O complex 130 and configures the GPIO signals to keep the power switch 202 ON until the software can take control of these GPIOs.

Referring to FIG. 3, a block diagram implementation of the logic 140 is shown, according to an embodiment. In various embodiments, logic 140 can be implemented using logic gates or a low cost OTP (One Time Programmable) FPGAs (Field-Programmable Gate Arrays) configured for this functionality. For example, input(s)/GPIOs (e.g., IN 1 and IN 2) from I/O complex 130 may be used in conjunction with a control enable signal (labeled CNTRL_EN in FIG. 3, which may be generated by the I/O complex but it could also be generated by an Embedded Controller (EC) on the platform) may be used to look up an output (e.g., OUT 1 and OUT2) to be provided to a switch (e.g., switch 202 of FIG. 2) based on values stored in a lookup table (LUT). In an embodiment, the output of the device should be push pull (instead of open drain) to ensure that there is no further power loss while in low power states due to a Open Drain resistor. In an embodiment, a single CNTRL_EN signal can be used for all the GPIOs used on the platform. This can reduce the idle power loss on platform from N×PL to 1×PL, where N is the number of un-configured GPIOs used on platform for RTD3 power gating and PL is the Power Loss discussed above.

In an embodiment, the power loss may be further reduced by using a signal from I/O complex which indicates that the BIOS code has been executed and has taken control of the I/O complex GPIO. One such signal is DRAMRST# (which stands for Dynamic Random Access Memory Reset, e.g., where this signal is used by CPU memory controller to bring system memory out of reset after the configuration of memory is completed by BIOS) in accordance with at least one I/O complex implementation. This signal is a I/O complex GPIO driven high by BIOS during MRC (Memory Reference Code) execution to release DRAM (Dynamic Random Access Memory) from reset. BIOS can be used to program the power control GPIOs prior to releasing DRAMRST# to memory in an embodiment, e.g., as discussed with reference to FIG. 4.

FIG. 4 illustrates a flow diagram of a method 400 for programming the power control GPIO(s), according to an embodiment. Method 400 may be used to (e.g., via BIOS) to program the power control GPIOs prior to releasing DRAMRST# to memory. In some embodiments, various components discussed with reference to FIGS. 1-3 and 5-6 may be utilized to perform one or more of the operations discussed with reference to FIG. 4. For example, the logic 140 may be used to control power consumption of one or more devices 150 and/or perform one or more of the operations discussed with reference to method 400.

Referring to FIGS. 1-4, at an operation 402, the system (also referred to herein interchangeable as the “platform”) is in Sx until a wake event is detected at operation 404. At an operation 406, system rails are powered up after the wake event of operation 404. At an operation 408, DRAMRST# is set to 0 (or 1 depending on the implementation) or asserted to turn on the power control GPIO. At an operation 410, the platform exits reset. BIOS execution starts at operation 412. If power control GPIOs are not configured at operation 414, the BIOS configures the GPIOs at operation 416. At an operation 418 (or if power control GPIOS are configured per operation 414), DRAMRST# is set to 1 (or 0 depending on the implementation) or deasserted. At an operation 420, PCH GPIO control the power switch(es) 202.

In some embodiments, the BIOS flow of FIG. 4 needs to only ensure that the GPIO configuration is completed prior to releasing DRAMRST# to the platform and the logic 140 on the platform can then handover the control of the Power FET switch(es) 202 to the I/O complex GPIOs with minimal power consumption (e.g., to allow software also referred to herein as OS, application(s), etc. to take control of the switch(es) 202). When the platform moves to a low power state like S0iX or S3, DRAMRST# would continue to stay high and software could choose to turn off devices which are unnecessary without any additional power penalty due to GPIO state. Moreover, during system power down sequence, DRAMRST# would be driven low (or high depending on the implementation) or asserted at some point and this might force the switch(es) to turn on accidently assuming that I/O complex 130 is not in control, but this can be eliminated by powering off the control logic block as appropriate (e.g., for I/O complex core well GPIOs may use S0 rail to power control block and for I/O complex suspend well GPIOs may use SUS well). Accordingly, with additional control logic 140 described herein, idle platform power consumption may be minimized/reduced by using/modifying existing signal and sequence architecture.

FIG. 5 illustrates a block diagram of a computing system 500 in accordance with an embodiment of the invention. The computing system 500 may include one or more central processing unit(s) (CPUs) 502 or processors that communicate via an interconnection network (or bus) 504. The processors 502 may include a general purpose processor, a network processor (that processes data communicated over a computer network 503), or other types of a processor (including a reduced instruction set computer (RISC) processor or a complex instruction set computer (CISC)).

Moreover, the processors 502 may have a single or multiple core design. The processors 502 with a multiple core design may integrate different types of processor cores on the same integrated circuit (IC) die. Also, the processors 502 with a multiple core design may be implemented as symmetrical or asymmetrical multiprocessors. In an embodiment, one or more of the processors 502 may be the same or similar to the processors 102 of FIG. 1. For example, one or more components of system 500 may include one or more of items 130, 140, and 150 discussed with reference to FIGS. 1-4. Also, the operations discussed with reference to FIGS. 1-4 may be performed by one or more components of the system 500.

A chipset 506 may also communicate with the interconnection network 504. The chipset 506 may include a memory control hub (MCH) 508. The MCH 508 may include a memory controller 510 that communicates with a memory 512 (which may be the same or similar to the memory 114 of FIG. 1). The memory 512 may store data, including sequences of instructions, that may be executed by the CPU 502, or any other device included in the computing system 500. In one embodiment of the invention, the memory 512 may include one or more volatile storage (or memory) devices such as random access memory (RAM), dynamic RAM (DRAM), synchronous DRAM (SDRAM), static RAM (SRAM), or other types of storage devices. Nonvolatile memory may also be utilized such as a hard disk. Additional devices may communicate via the interconnection network 504, such as multiple CPUs and/or multiple system memories.

The MCH 508 may also include a graphics interface 514 that communicates with a display device 516. In one embodiment of the invention, the graphics interface 514 may communicate with the display device 516 via an accelerated graphics port (AGP). In an embodiment of the invention, the display 516 (such as a flat panel display) may communicate with the graphics interface 514 through, for example, a signal converter that translates a digital representation of an image stored in a storage device such as video memory or system memory into display signals that are interpreted and displayed by the display 516. The display signals produced by the display device may pass through various control devices before being interpreted by and subsequently displayed on the display 516.

A hub interface 518 may allow the MCH 508 and an input/output control hub (ICH) 520 to communicate. The ICH 520 may provide an interface to I/O device(s) that communicate with the computing system 500. The ICH 520 may communicate with a bus 522 through a peripheral bridge (or controller) 524, such as a peripheral component interconnect (PCI) bridge, a universal serial bus (USB) controller, or other types of peripheral bridges or controllers. The bridge 524 may provide a data path between the CPU 502 and peripheral devices. Other types of topologies may be utilized. Also, multiple buses may communicate with the ICH 520, e.g., through multiple bridges or controllers. Moreover, other peripherals in communication with the ICH 520 may include, in various embodiments of the invention, integrated drive electronics (IDE) or small computer system interface (SCSI) hard drive(s), USB port(s), a keyboard, a mouse, parallel port(s), serial port(s), floppy disk drive(s), digital output support (e.g., digital video interface (DVI)), or other devices.

The bus 522 may communicate with an audio device 526, one or more disk drive(s) 528, and a network interface device 530 (which is in communication with the computer network 503). Other devices may communicate via the bus 522. Also, various components (such as the network interface device 530) may communicate with the MCH 508 in some embodiments of the invention. In addition, the processor 502 and the MCH 508 may be combined to form a single chip. Furthermore, the graphics accelerator 516 may be included within the MCH 508 in other embodiments of the invention.

Furthermore, the computing system 500 may include volatile and/or nonvolatile memory (or storage). For example, nonvolatile memory may include one or more of the following: read-only memory (ROM), programmable ROM (PROM), erasable PROM (EPROM), electrically EPROM (EEPROM), a disk drive (e.g., 528), a floppy disk, a compact disk ROM (CD-ROM), a digital versatile disk (DVD), flash memory, a magneto-optical disk, or other types of nonvolatile machine-readable media that are capable of storing electronic data (e.g., including instructions).

FIG. 6 illustrates a computing system 600 that is arranged in a point-to-point (PtP) configuration, according to an embodiment of the invention. In particular, FIG. 6 shows a system where processors, memory, and input/output devices are interconnected by a number of point-to-point interfaces. The operations discussed with reference to FIGS. 1-5 may be performed by one or more components of the system 600.

As illustrated in FIG. 6, the system 600 may include several processors, of which only two, processors 602 and 604 are shown for clarity. The processors 602 and 604 may each include a local memory controller hub (MCH) 606 and 608 to enable communication with memories 610 and 612. The memories 610 and/or 612 may store various data such as those discussed with reference to the memory 512 of FIG. 5.

In an embodiment, the processors 602 and 604 may be one of the processors 502 discussed with reference to FIG. 5. The processors 602 and 604 may exchange data via a point-to-point (PtP) interface 614 using PtP interface circuits 616 and 618, respectively. Also, the processors 602 and 604 may each exchange data with a chipset 620 via individual PtP interfaces 622 and 624 using point-to-point interface circuits 626, 628, 630, and 632. The chipset 620 may further exchange data with a graphics circuit 634 via a graphics interface 636, e.g., using a PtP interface circuit 637.

At least one embodiment of the invention may be provided within the processors 602 and 604. For example, one or more components of system 600 may include one or more of items 130, 140, and 150 of FIGS. 1-5, including located within the processors 602 and 604. Other embodiments of the invention, however, may exist in other circuits, logic units, or devices within the system 600 of FIG. 6. Furthermore, other embodiments of the invention may be distributed throughout several circuits, logic units, or devices illustrated in FIG. 6.

The chipset 620 may communicate with a bus 640 using a PtP interface circuit 641. The bus 640 may communicate with one or more devices, such as a bus bridge 642 and I/O devices 643. Via a bus 644, the bus bridge 642 may communicate with other devices such as a keyboard/mouse 645, communication devices 646 (such as modems, network interface devices, or other communication devices that may communicate with the computer network 503), audio I/O device 647, and/or a data storage device 648. The data storage device 648 may store code 649 that may be executed by the processors 602 and/or 604.

In some embodiments, one or more of the components discussed herein can be embodied as a System On Chip (SOC) device. FIG. 7 illustrates a block diagram of an SOC package in accordance with an embodiment. As illustrated in FIG. 7, SOC 702 includes one or more Central Processing Unit (CPU) cores 720, one or more Graphics Processor Unit (GPU) cores 730, an Input/Output (I/O) interface 740, and a memory controller 742. Various components of the SOC package 702 may be coupled to an interconnect or bus such as discussed herein with reference to the other figures. Also, the SOC package 702 may include more or less components, such as those discussed herein with reference to the other figures. Further, each component of the SOC package 720 may include one or more other components, e.g., as discussed with reference to the other figures herein. In one embodiment, SOC package 702 (and its components) is provided on one or more Integrated Circuit (IC) die, e.g., which are packaged into a single semiconductor device.

As illustrated in FIG. 7, SOC package 702 is coupled to a memory 760 (which may be similar to or the same as memory discussed herein with reference to the other figures) via the memory controller 742. In an embodiment, the memory 760 (or a portion of it) can be integrated on the SOC package 702.

The I/O interface 740 may be coupled to one or more I/O devices 770, e.g., via an interconnect and/or bus such as discussed herein with reference to other figures. I/O device(s) 770 may include one or more of a keyboard, a mouse, a touchpad, a display, an image/video capture device (such as a camera or camcorder/video recorder), a touch screen, a speaker, or the like. Furthermore, SOC package 702 may include/integrate the logic 140 in an embodiment. Alternatively, the logic 140 may be provided outside of the SOC package 702 (i.e., as a discrete logic).

The following examples pertain to further embodiments. Example 1 includes an apparatus comprising: logic, the logic at least partially comprising hardware logic, to transfer control of a power state of a device to one or more general purpose input output signals, wherein the logic is to generate a signal to control the power state of the device via a switch and wherein the logic is to generate the signal, at least in part, based on the one or more general purpose input output signals and a control enable signal. In example 2, the subject matter of example 1 can optionally include an apparatus, wherein one of an Input/Output (I/O) complex and a bridge logic, coupled to the device through the logic, is to generate the one or more general purpose input output signals. In example 3, the subject matter of example 2 can optionally include an apparatus, wherein the I/O complex or the bridge logic is to generate the one or more general purpose input output signals in response to an indication from software. In example 4, the subject matter of example 1 can optionally include an apparatus, wherein the logic is to transfer control of the power state of the device to the one or more general purpose input output signals in response to detection of a wake event from a low power consumption state and configuration of the one or more general purpose input output signals. In example 5, the subject matter of example 1 can optionally include an apparatus, wherein a Basic Input Output System (BIOS) is to configure the one or more general purpose input output signals. In example 6, the subject matter of example 5 can optionally include an apparatus, wherein the BIOS is to configure the one or more general purpose input output signals prior to assertion or deassertion of a signal. In example 7, the subject matter of example 1 can optionally include an apparatus, wherein the switch is to comprise a run time D3 compliant switch. In example 8, the subject matter of example 1 can optionally include an apparatus, further comprising memory to store operating system software, wherein the operating system software is to control the power state of the device via the one or more general purpose input output signals. In example 9, the subject matter of example 1 can optionally include an apparatus, wherein the logic, one or more processor cores, and memory are located on a single integrated circuit die.

Example 10 includes a method comprising: transferring control of a power state of a device to one or more general purpose input output signals, wherein a signal is generated to control the power state of the device via a switch, at least in part, based on the one or more general purpose input output signals and a control enable signal. In example 11, the subject matter of example 10 can optionally include a method, further comprising one of a I/O complex and a bridge logic generating the one or more general purpose input output signals. In example 12, the subject matter of example 11 can optionally include a method, wherein the I/O complex or the bridge logic generate the one or more general purpose input output signals in response to an indication from software. In example 13, the subject matter of example 10 can optionally include a method, further comprising transferring control of the power state of the device to the one or more general purpose input output signals in response to detection of a wake event from a low power consumption state and configuration of the one or more general purpose input output signals. In example 14, the subject matter of example 10 can optionally include a method, further comprising a Basic Input Output System (BIOS) configuring the one or more general purpose input output signals. In example 15, the subject matter of example 14 can optionally include a method, further comprising the BIOS configuring the one or more general purpose input output signals prior to assertion or deassertion of a signal. In example 16, the subject matter of example 14 can optionally include a method, further comprising storing an operating system software in memory, wherein the operating system software controls the power state of the device via the one or more general purpose input output signals.

Example 17 includes a system comprising: an I/O complex to generate one or more general purpose input output signals; logic, the logic at least partially comprising hardware logic, to transfer control of a power state of a device to at least one of the one or more general purpose input output signals based, at least in part, on data stored in a memory, wherein the logic is to generate a signal to control the power state of the device via a switch and wherein the logic is to generate the signal, at least in part, based on the one or more general purpose input output signals and a control enable signal. In example 18, the subject matter of example 17 can optionally include a system, wherein one of the I/O complex is coupled to the device via the logic and the switch. In example 19, the subject matter of example 18 can optionally include a system, wherein the I/O complex is to generate the one or more general purpose input output signals in response to an indication from software. In example 20, the subject matter of example 17 can optionally include a system, wherein the logic is to transfer control of the power state of the device to the one or more general purpose input output signals in response to detection of a wake event from a low power consumption state and configuration of the one or more general purpose input output signals. In example 21, the subject matter of example 17 can optionally include a system, wherein a Basic Input Output System (BIOS) is to configure the one or more general purpose input output signals. In example 22, the subject matter of example 21 can optionally include a system, wherein the BIOS is to configure the one or more general purpose input output signals prior to assertion or deassertion of a signal. In example 23, the subject matter of example 17 can optionally include a system, wherein the switch is to comprise a run time D3 compliant switch. In example 24, the subject matter of example 17 can optionally include a system, wherein the memory is to store operating system software, wherein the operating system software is to control the power state of the device via the one or more general purpose input output signals. In example 25, the subject matter of example 17 can optionally include a system, wherein the logic, one or more processor cores, and the memory are located on a single integrated circuit die.

Example 26 includes a computer-readable medium comprising one or more instructions that when executed on a processor configure the processor to perform one or more operations of any of examples 10 to 16.

Example 27 includes an apparatus to reduce power consumption during one or more idle states, the apparatus comprising: means for transferring control of a power state of a device to one or more general purpose input output signals; and means for generating a signal to control the power state of the device via a switch, at least in part, based on the one or more general purpose input output signals and a control enable signal. In example 28, the subject matter of example 27 can optionally include an apparatus, further comprising means for one of a I/O complex and a bridge logic to generate the one or more general purpose input output signals. In example 29, the subject matter of example 27 can optionally include an apparatus, further comprising means for one of a I/O complex and a bridge logic to generate the one or more general purpose input output signals in response to an indication from software. In example 30, the subject matter of example 27 can optionally include an apparatus, further comprising means for transferring control of the power state of the device to the one or more general purpose input output signals in response to detection of a wake event from a low power consumption state and configuration of the one or more general purpose input output signals. In example 31, the subject matter of example 27 can optionally include an apparatus, further comprising means for a Basic Input Output System (BIOS) to configure the one or more general purpose input output signals. In example 32, the subject matter of example 27 can optionally include an apparatus, further comprising means for a BIOS to configure the one or more general purpose input output signals prior to assertion or deassertion of a signal. In example 33, the subject matter of example 27 can optionally include an apparatus, further comprising means for storing an operating system software in memory, wherein the operating system software controls the power state of the device via the one or more general purpose input output signals.

Example 34 can include the apparatus of examples 3 or 5, wherein one or more of the BIOS and the software are stored in memory.

Example 35 can include the apparatus of examples 3, 5, or 8, wherein one or more of the BIOS, the software, and the operating system are stored in a same memory device.

In various embodiments of the invention, the operations discussed herein, e.g., with reference to FIGS. 1-7, may be implemented as hardware (e.g., logic circuitry), software, firmware, or combinations thereof, which may be provided as a computer program product, e.g., including (e.g., a non-transitory) machine-readable or computer-readable medium having stored thereon instructions (or software procedures) used to program a computer to perform a process discussed herein. The machine-readable medium may include a storage device such as those discussed with respect to FIGS. 1-7.

Additionally, such computer-readable media may be downloaded as a computer program product, wherein the program may be transferred from a remote computer (e.g., a server) to a requesting computer (e.g., a client) by way of data signals embodied in a carrier wave or other propagation medium via a communication link (e.g., a bus, a modem, or a network connection).

Reference in the specification to “one embodiment,” “an embodiment,” or “some embodiments” means that a particular feature, structure, or characteristic described in connection with the embodiment(s) may be included in at least an implementation. The appearances of the phrase “in one embodiment” in various places in the specification may or may not be all referring to the same embodiment.

Also, in the description and claims, the terms “coupled” and “connected,” along with their derivatives, may be used. In some embodiments of the invention, “connected” may be used to indicate that two or more elements are in direct physical or electrical contact with each other. “Coupled” may mean that two or more elements are in direct physical or electrical contact. However, “coupled” may also mean that two or more elements may not be in direct contact with each other, but may still cooperate or interact with each other.

Thus, although embodiments of the invention have been described in language specific to structural features and/or methodological acts, it is to be understood that claimed subject matter may not be limited to the specific features or acts described. Rather, the specific features and acts are disclosed as sample forms of implementing the claimed subject matter.

1. An apparatus comprising:
logic, the logic at least partially comprising hardware logic, to transfer control of a power state of a device to one or more general purpose input output signals,
wherein the logic is to generate a signal to control the power state of the device via a switch and wherein the logic is to generate the signal, at least in part, based on the one or more general purpose input output signals and a control enable signal.

2. The apparatus of claim 1, wherein one of an Input/Output (I/O) complex and a bridge logic, coupled to the device through the logic, is to generate the one or more general purpose input output signals.

3. The apparatus of claim 2, wherein the I/O complex or the bridge logic is to generate the one or more general purpose input output signals in response to an indication from software.

4. The apparatus of claim 1, wherein the logic is to transfer control of the power state of the device to the one or more general purpose input output signals in response to detection of a wake event from a low power consumption state and configuration of the one or more general purpose input output signals.

5. The apparatus of claim 1, wherein a Basic Input Output System (BIOS) is to configure the one or more general purpose input output signals.

6. The apparatus of claim 5, wherein the BIOS is to configure the one or more general purpose input output signals prior to assertion or deassertion of a signal.

7. The apparatus of claim 1, wherein the switch is to comprise a run time D3 compliant switch.

8. The apparatus of claim 1, further comprising memory to store operating system software, wherein the operating system software is to control the power state of the device via the one or more general purpose input output signals.

9. The apparatus of claim 1, wherein the logic, one or more processor cores, and memory are located on a single integrated circuit die.

10. A method comprising:
transferring control of a power state of a device to one or more general purpose input output signals,
wherein a signal is generated to control the power state of the device via a switch, at least in part, based on the one or more general purpose input output signals and a control enable signal.

11. The method of claim 10, further comprising one of a I/O complex and a bridge logic generating the one or more general purpose input output signals.

12. The method of claim 11, wherein the I/O complex or the bridge logic generate the one or more general purpose input output signals in response to an indication from software.

13. The method of claim 10, further comprising transferring control of the power state of the device to the one or more general purpose input output signals in response to detection of a wake event from a low power consumption state and configuration of the one or more general purpose input output signals.

14. The method of claim 10, further comprising a Basic Input Output System (BIOS) configuring the one or more general purpose input output signals.

15. The method of claim 14, further comprising the BIOS configuring the one or more general purpose input output signals prior to assertion or deassertion of a signal.

16. The method of claim 14, further comprising storing an operating system software in memory, wherein the operating system software controls the power state of the device via the one or more general purpose input output signals.

17. A system comprising:
an I/O complex to generate one or more general purpose input output signals;
logic, the logic at least partially comprising hardware logic, to transfer control of a power state of a device to at least one of the one or more general purpose input output signals based, at least in part, on data stored in a memory,
wherein the logic is to generate a signal to control the power state of the device via a switch and wherein the logic is to generate the signal, at least in part, based on the one or more general purpose input output signals and a control enable signal.

18. The system of claim 17, wherein one of the I/O complex is coupled to the device via the logic and the switch.

19. The system of claim 18, wherein the I/O complex is to generate the one or more general purpose input output signals in response to an indication from software.

20. The system of claim 17, wherein the logic is to transfer control of the power state of the device to the one or more general purpose input output signals in response to detection of a wake event from a low power consumption state and configuration of the one or more general purpose input output signals.

21. The system of claim 17, wherein a Basic Input Output System (BIOS) is to configure the one or more general purpose input output signals.

22. The system of claim 21, wherein the BIOS is to configure the one or more general purpose input output signals prior to assertion or deassertion of a signal.

23. The system of claim 17, wherein the switch is to comprise a run time D3 compliant switch.

24. The system of claim 17, wherein the memory is to store operating system software, wherein the operating system software is to control the power state of the device via the one or more general purpose input output signals.

25. The system of claim 17, wherein the logic, one or more processor cores, and the memory are located on a single integrated circuit die.
